(19) United States
(12) Patent Application Publication
(10) Pub. No.: US 2014/0298634 A1
(43) Pub. Date: Oct. 9, 2014

(54) COMPONENT HANDLING ASSEMBLY

(71) Applicant: ISMECA Semiconductor Holding SA, La Chaux-de-Fonds (CH)

(72) Inventors: Giovanni Palmisano, La Chaux-de-Fonds (CH); Jacques André Matthey Junod, Le Locle (CH); Pascal Dromard, Montlebon (FR); Philippe Roy, Gilley (FR)

(73) Assignee: ISMECA SEMICONDUCTOR HOLDING SA, La Chaux-de-Fonds (CH)

(21) Appl. No.: 14/363,697

(22) PCT Filed: Dec. 7, 2011
(86) PCT No.: PCT/EP2011/072134

§ 371 Date: Jun. 6, 2014

(51) Int. Cl. B23P 19/00; B23P 19/04; B23P 19/027

(52) U.S. Cl. CPC B23P 19/002; B23P 19/007; B23P 19/027; B23P 19/04
USPC 29/407.1; 29/783; 29/785; 29/792; 29/712

(57) ABSTRACT

According to the present invention there is provided a component handling assembly, comprising, an index table which comprises one or more nests each of which is configured to cooperate with a component to hold the component as the index table is indexed, wherein the one or more nests are configured such that a component which cooperates with a nest is supported above the nest so that the one or more nests can cooperate with components of various sizes, and an alignment means operable to move a component into a predefined orientation before a component co-operates with a nest on the index table. There is further provided a corresponding method of handling a component.

### FIELD OF THE INVENTION

The present invention concerns a component handling assembly, and in particular a component handling assembly which comprises an index table which comprises one or more nests which can hold components of various sizes, and an alignment means operable to move a component into a predefined orientation before a component co-operates with a nest.

### DESCRIPTION OF RELATED ART

Component handling assemblies typically have a main turret on which components are held. The turret rotates to transport components; usually, the turret rotates intermittently to transport components between processing stations which are located at a periphery of the turret. The turret rotates one iteration, and the components held on the turret are dropped to respective, adjacent, processing stations. The processing stations process the components, and the components are picked again, before the turret rotates a further iteration to transport the components to the next processing station.

Often a processing station executes a plurality of processing steps on a component. In such cases a satellite table or index table can be provided adjacent to the turret. The plurality of processors, required to carry out the plurality of processing steps, are each located at a periphery of the satellite table or index table; these processors carry out the plurality of processing steps, and the satellite table or index table rotates to transport components between the plurality of processors. Components to be processed are dropped from the turret to the satellite table or index table, while simultaneously, components which have already undergone the plurality of processing steps are picked from the satellite table or index table and are returned to the turret so that they can be transported to the next processing station.

Often the components are required to have a predefined orientation or position on the satellite table or index table; for example one or more of the plurality of processors may require that the component be in a predefined orientation so that the processor can carry out processing of the component. Current satellite tables or index tables are provided with recesses which have a shape and size corresponding to the components; the components which are dropped from the turret, are received into the recesses on the satellite table or index table. The walls which define the recesses will force the components into a predefined orientation and position on the satellite table or index table. The walls which define the recesses will also stabilise the position of the components as the satellite table or index table rotates to transport components between the plurality of processors.

However, the recesses are only designed to receive components of a certain size. Components which are larger than the recesses will not fit into the recess and therefore cannot be stabilised on the satellite table or index table. Components which are smaller than the recesses will not be forced by the walls which define the recesses, into a predefined orientation and position on the satellite table or index table. Thus, existing component handling assemblies are limited in that they are only configured to handling components of a predefined size.

It is an aim of the present invention to mitigate, or obviate, at least some of the above-mentioned disadvantages.

### BRIEF SUMMARY OF THE INVENTION

According to the invention, these aims are achieved by means of a component handling assembly, comprising, an index table which comprises one or more nests each of which is configured to cooperate with a component to hold the component as the index table is indexed, wherein the one or more nests are configured such that a component which cooperates with a nest is supported above the nest so that the one or more nests can cooperate with components of various sizes, and an alignment means operable to move a component into a predefined orientation before a component co-operates with a nest on the index table.

The component handling assembly may comprise a turret on which one or more components can be held, and which can rotate to transport the one or more components, and the alignment means may be configured such that it can move a component into the predefined orientation while the component is held on the turret.

Each of the one or more nests may comprise a flat surface which defines a top of the nest, wherein the flat surface is configured such that it can cooperate with a component to support a component.

The index table may be configured such that the one or more nests may be removable from the index table. The index table may be configured such that the one or more nests may be replaceable on the index table.

The one or more nest may each comprises a means by which a vacuum force may be applied to components which co-operate with the one or more nests, to hold the components on the one or more nest.

The means by which a vacuum force may be applied to a component may comprise a conduit which is configured to be in fluid communication with the flat nest and can be configured to be in fluid communication with a vacuum generating means. It will be understood that any suitable means may be used. The means by which a vacuum force may be applied to a component may comprise a conduit which is configured to be in fluid communication with a flat surface which defines a top of the nest and which can be configured to be in fluid communication with a vacuum generating means. It will be understood that any suitable means by which a vacuum force may be applied to a component may be used.

The conduit may be integral to each of the one or more nests.

The vacuum force may be applied intermittently, or constantly. For example, the vacuum force may be applied intermittently, only as the index table in indexed, or may be applied constantly so that the component is always held in position, both when the index table is indexed and when it is not indexed.

Each nest may comprise conduit which each of which may be fluidly connected to a vacuum generating means. The vacuum generating means may be a central vacuum generating means which can be fluidly connected to a plurality of conduits in a plurality of nests. Thus, the central vacuum generating means can simultaneously provide a vacuum which will apply a vacuum force to a plurality of components on a plurality of nests, to hold the components in position their respective nests.

Preferably, a central vacuum generating means is provided, which is independent of the nest, but can be arranged in fluid communication with one or more conduit defined in one or more nests. Advantageously, this will allow the vacuum generating means to be independent of the nest size.

The index table may further comprise a vacuum generating means which is arranged in fluid communication the conduits in the one or more nests.

A component handling assembly may further comprise a detection means to detect the orientation of a component which cooperates with a nest.

A position correction means may be provided in operable communication with the index table, wherein the position connection means is operable to move a component on the nest, which has become displaced from a predefined orientation, to return the component to the predefined orientation on the nest.

According to a further aspect of the present invention there is provided a method of handling a component, comprising the steps of transporting a component using a turret; moving the component into a predefined orientation, while the component is held on the turret; transferring the component onto an index table such that the component has a predefined orientation on the index table.

The step of the method may be repeated two or more times.

The step of transferring the component onto an index table may comprise the step of transferring the component onto a nest on the index table.

The step of transferring the component onto an index table may comprise the step of transferring the component onto a surface which defines a top of the nest on the index table.

A method may further comprise the step of applying a vacuum force to the component to hold the component in the predefined orientation on nest of the index table.

A method may further comprise the step of detecting the orientation of a component. For example, the orientation of the component may be detected after the component has been moved into its predefined orientation, to ensure that the component has been moved to the predefined orientation, and/or the orientation of the component may be detected after the component has been transferred to the index table to ensure that the component has not become displaced during transfer and/or the orientation of the component on the turret may be detected to determine how much, or in which direction, the component should be moved so that it is in the predefined orientation.

### BRIEF DESCRIPTION OF THE DRAWINGS

The invention will be better understood with the aid of the description of an embodiment given by way of example and illustrated by the figures, in which:

FIG. 1 shows a perspective view of a component handling assembly according to one embodiment of the present invention;

FIG. 2 shows a magnified, perspective view of a nest on the index table of the component handling assembly of FIG. 1;

FIG. 3 provided a perspective view of the index table used in the component handling assembly shown in FIG. 1.

### DETAILED DESCRIPTION OF POSSIBLE EMBODIMENTS OF THE INVENTION

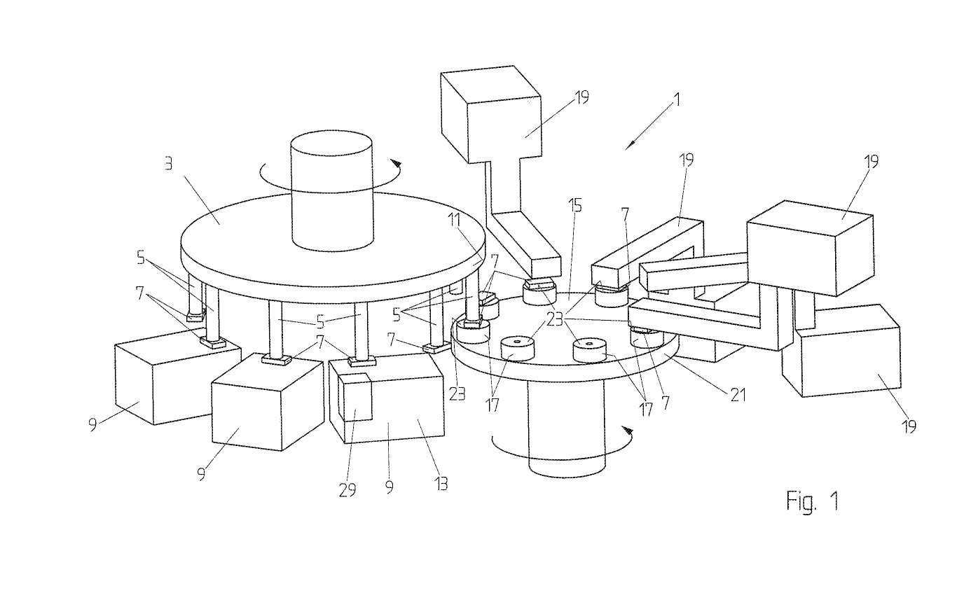

FIG. 1 shows a perspective view of a component handling assembly 1 according to one embodiment of the present invention

The component handling assembly 1, comprises a turret 3 which comprises a plurality of handling heads 5 which can cooperate with a component 7 to hold the component 7. The turret 3 can rotate to transport components 7, between a plurality of processing stations 9 which are located at a periphery 11 of the turret 3.

An alignment means 13 defines one of the plurality of processing stations 9. The alignment means is configured such that it can move a component 7 into the predefined orientation while the component is held by the handling heads 5 on the turret 3.

Optionally, a detection means, in the form of a detector 29 defines another of the plurality of processing stations 9. Preferably, the detector 29 defines the processing stations 9 which follows the alignment means 13. A detector 29 may also be incorporated into the alignment means 13 to aid the alignment means in aligning the component 7 into the predefined orientation. The detector 29 is configured to detect the orientation of a component 7, to check that the alignment means 13 was successful in moving the component 7 into the predefined orientation. In this particular example the detector 29 is integral to the alignment means 13.

The component handling assembly 1 further comprises an index table 15. The index table 15 defines a one of the plurality of processing stations 9 which are located at a periphery 11 of the turret 3; preferably the index table 15 defines a processing station 9 after the alignment means 13 so that a component can be aligned to the predefined orientation before it is reaches the index table 15.

A plurality of processors 19 are located at a periphery 11 of the index table 15, and the index table can be index, or rotated intermittently, to transport components between the processors 19. The plurality of processors 19 are each operable carry out different sub-processes; collectively the plurality of processors 19 implement a component processing process.

The index table 15 comprises a plurality of nests 17. Each of the plurality of nests 17 are configured to cooperate with a component 7 to hold the component 7 as the index table 15 is indexed. The one or more nests 17 are configured such that a component 7 which cooperates with a nest 17 is supported on a flat surface 23 which defines a top of the nest 17, so that the one or more nests 17 can cooperate with components 7 of various sizes.

In this particular example, all of the processors 19 which are located at a periphery 11 of the index table 15, require that each component 7 be in a predefined position on the nest 17, in order to process the component 7.

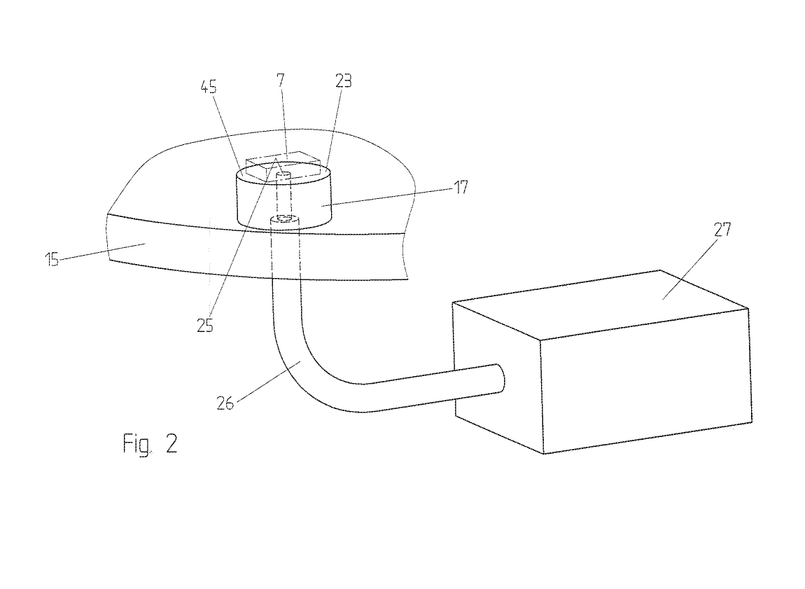

FIG. 2 provides a perspective, magnified, view of a nest 17. The features of a single nest 17 will be described, however it will be understood that some or each of the plurality of nests 17 on the index table 15 will have the same features. Preferably, each of the plurality of nests 17 on the index table 15 will have the same features.

Each nest 17 comprises a flat surface 23 which defines at least a top 25 of the nest 17. The flat surface 23 is configured such that it can cooperate with a component 7 to support a component 7.

Each nest 17 comprises a means by which a vacuum force may be applied to component 7 which co-operate with the nest 17. The vacuum force will act to hold the component 7 so that the position of the component 7 on the nest 17 can be maintained; in particular so that the position of the component 7 on the nest 17 can be maintained as the index table 15 indexes or rotates. In this particular example the means by which a vacuum force may be applied to a component comprises, a conduit 25 which is configured to be in fluid communication with the flat surface 23 of the nest 17, and a vacuum generating means 27 which is arranged in fluid communication with the conduit 25. The conduit 25 is integral to the nest 17. It will be understood that any other suitable means for applying a vacuum force to a component 7 on the nest 17, may be provided; and the means is not limited to a conduit 25 and vacuum generating means 27.

The vacuum generating means 27 may be operated to generate a vacuum; as the flat surface 23 of the nest 17 is in fluid communication with the vacuum generating means 27 via the conduit 25, a vacuum force will be applied to a component 7 which is supported on the flat surface 23 of the nest 17.

The vacuum generating means 27 may be operated to generate a constant vacuum or to generate a vacuum intermittently. For example, the vacuum generating means 27 may be operated to generate a vacuum intermittently, only as the index table 15 in indexed; or may be operated to generate a constant vacuum, so that the component 7 is always held in position, even when the index table 15 is not being indexed. In this particular example the vacuum generating means 27 is operated to generate a constant vacuum.

Optionally, a detection means, in the form of a detector (not shown) may be provided in cooperation with the index table. The detector may be configured to detect the orientation of a component 7 which cooperates with a nest 17 on the index table 15. A corrector (not shown) may also be provided in cooperation with the index table 15. The corrector is preferably operable to move a component 7 which cooperates with a nest 17, to a predetermined orientation, if the detector detects that the component 7 has become displaced from a predetermined orientation.

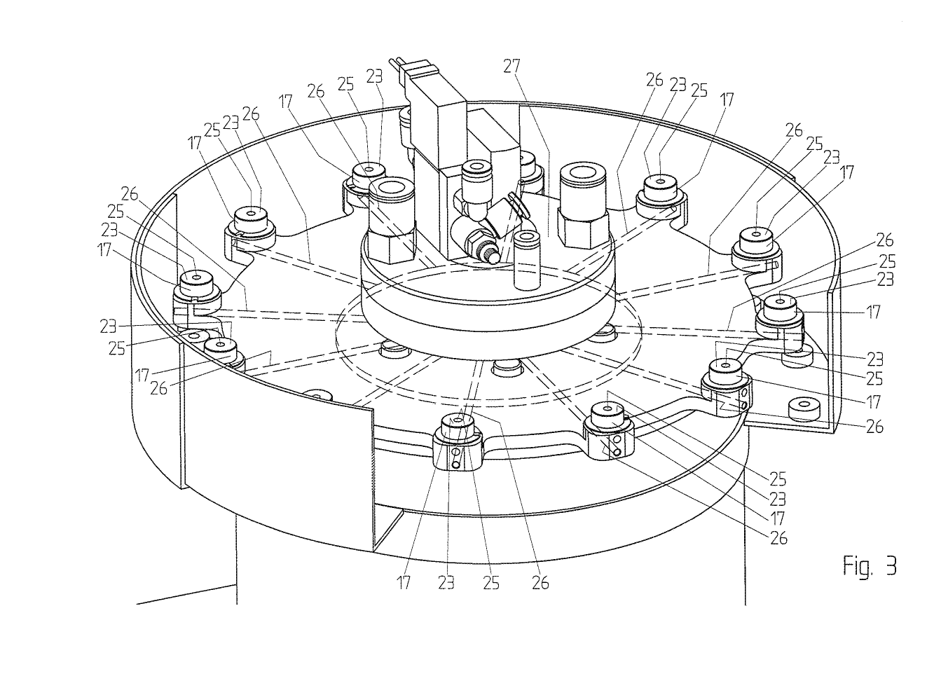

FIG. 3 provided a perspective view of the index table 15 used in the component handling assembly 1 shown in FIG. 1. As shown in the figure the vacuum generating means 27 is a central vacuum generating means 27 which is fluidly connected by means of pipes 26 to a plurality of conduits 25 defined in a plurality of nests 17. A vacuum provided by the generating means 27 is thus provided at each of the flat surfaces 23 which defines the top of each of the respective nests 17. Thus, the central vacuum generating means 27 can simultaneously provide a vacuum which will apply a vacuum force to a plurality of components 7 on a plurality of nests 17, to hold the components 7 in position on their respective nests 17. The central vacuum generating means 27 is provided independently of the nests 17 on the index table 15, but is arranged in fluid communication with the plurality of conduits 25 defined in the plurality of nests 17. Advantageously, this will allow the vacuum generating means 27 to be independent of the nest size.

Referring now to the FIGS. 1-3, during use, components 7 are held on the turret 3 by handling heads 5; preferably the components are vacuum held on the handling heads 5. The handling heads 5 extend to deliver the components 7 to the processing stations 9 which are located at the periphery of the turret 3. The processing stations 9 process the component and the handling heads 5 extend to pick the components 7 from the respective processing station 9. Once the components 7 have been picked, the turret 3 rotates one iteration and the handling heads 5 extend to deliver the components 7 to the next processing station 9.

An alignment means 13, which defines one of the plurality of processing stations 9, moves the component 7 into a predefined orientation while the component 7 is held by the handling heads 5 on the turret 3. The alignment means 13 moves the component 7 into an orientation, such that when the component 7 is delivered by the handling head 5 to a nest 17 on index table 15, the component will acquire an orientation on the nest which is required by the processors 19 to enable the processors 19 to process the component 7.

The detector 29, which is integral to the alignment means 13, will operate to check that the alignment means 13 was successful in moving the component 7 into the predefined orientation, before the component 7 is delivered by the handling head 5 to a nest 17 on index table 15.

After the alignment means 13 has aligned the component to the predefined orientation, the turret 3 is again indexed so that now the handling head 5 which hold the aligned component 7, is positioned above a nest 17 on the index table 15. The handling head 5 extends to deliver the component 7 onto the flat surface 23, which defines the top 25 of the nest 17. As the component 7 has already been aligned by the alignment means 13 which defined the preceding processing station 9, the component 7 will be delivered onto the flat surface 23 of the nest 17 in the predefined orientation which is required by the processors 19 to enable the processors 19 to process the component 7. Furthermore, as the nest 17 has a flat surface 23 which defines a top 45 of the nest 17, which cooperates with a component 7 to support the component 7, the component handling assembly 1 is not restricted to handling components 7 of a particular size; the component handling assembly 1 can in fact handle components of various different sizes as the flat surface 23 provides an unrestricted plane on which any sized component 7 can be supported.

To aid the delivery of the component to the nest 17 of the index table 15, when the handling head 5 extends to deliver the component 7 onto the flat surface 23 of the nest 17, the vacuum generating means 27 may be operated to generate a vacuum. As the flat surface 23 of the nest 17 is in fluid communication with the vacuum generating means 27 via the conduit 25, a vacuum force will be applied to the component 7 which is held proximate to the flat surface 23 by the handling head 5. The vacuum force will pull the component 7 from the handling head 5, towards the flat surface 23 of the nest 17. Simultaneously, the vacuum applied at the handling head 5 to hold the component 7 on the handling head 5 is shut off or reduced, thus allowing the component 7 to be pulled towards the flat surface 23 of the nest 17.

The vacuum force, generated by the vacuum generating means 27, will continue to be applied to the component 7 after it has been delivered onto the flat surface 23 of the nest 17. This will ensure that the component 7 will maintain the predefined orientation which is required by the processors 19 to enable the processors 19 to process the component 7.

While a component 7 is being delivered to the index table 15, another component 7, which has already being processed by each of the processors 19, is picked from the index table 15 by the next handling head 5 on the turret 3.

The index table 15 then rotates iteratively, to transport the component 7 to each of the processors 19 which are located at the periphery 11 of the index table 15. The vacuum force, generated by the vacuum generating means 27, will maintain the component 7 in the predefined orientation as the index table 15 rotates. Thus, the component 7 will be presented to each processor 19 in the orientation required to enable the processor 19 to carry out processing of the component 7.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment

1. A component handling assembly, comprising,
an index table which comprises one or more nests each of which is configured to cooperate with a component to hold the component as the index table is indexed, wherein the one or more nests are configured such that a component which cooperates with a nest is supported above the nest so that the one or more nests can cooperate with components of various sizes, and
an alignment means operable to move a component into a predefined orientation before a component co-operates with a nest on the index table.

2. A component handling assembly according to claim 1 comprising a turret on which one or more components can be held, and which can rotate to transport the one or more components, and the alignment means is configured such that it can move a component into the predefined orientation while the component is held on the turret.

3. A component handling assembly according to claim 1, wherein each of the one or more nests comprise a flat surface which defines at a top of the nest, wherein the flat surface is configured such that it can cooperate with a component to support a component.

4. A component handling assembly according to claim 1, wherein the one or more nest each comprises a means by which a vacuum force may be applied to components which co-operate with the one or more nests, to hold the components on the one or more nest.

5. A component handling assembly according to claim 4 wherein the means by which a vacuum force may be applied to a component comprise a conduit which is configured to be in fluid communication with the flat nest and can be configured to be in fluid communication with a vacuum generating means.

6. A component handling assembly according to claim 5 wherein the conduit is integral to each of the one or more nests.

7. A component handling assembly according to claim 5, further comprising a vacuum generating means which is arranged in fluid communication with the conduits defined in the one or more nests.

8. A component handling assembly according to claim 1, further comprises a detection means operable to detect the orientation of a component which cooperates with a nest.

9. A component handling assembly according to claim 8, wherein the assembly further comprises a position correction means which is operable to move a component, which has become displaced from a predefined orientation, to return the component to the predefined orientation.

10. A method of handling a component, comprising the steps of transporting a component using a turret; moving the component into a predefined orientation, while the component is held on the turret; transferring the component onto a top surface of a nest on the index table such that the component has a predefined orientation on the index table.

11. (canceled)

12. A method according to claim 10 further comprising the step of apply a vacuum force to the component to hold the component in the predefined orientation on a nest of the index table.

13. A method according to claim 10 further comprising the step of detecting the orientation of a component on the nest of the index table.
